(19) United States
(12) Patent Application Publication
(10) Pub. No.: US 2020/0301963 A1
(43) Pub. Date: Sep. 24, 2020

(54) Mode-Based Recommendations in Streaming Music

(71) Applicant: Pandora Media, LLC, Oakland, CA (US)

(72) Inventor: Andrew J. Asman, Oakland, CA (US)

(21) Appl. No.: 16/817,437

(22) Filed: Mar. 12, 2020

Related U.S. Application Data
(60) Provisional application No. 62/820,185, filed on Mar. 18, 2019.

(51) Int. Cl. G06F 16/638; H04L 29/06; G06F 16/64; G06F 16/683

(52) U.S. Cl. CPC G06F 16/639; G06F 16/683; G06F 16/64; H04L 65/604

(57) ABSTRACT

A system and method are disclosed for providing mode-based recommendations to a user. In an embodiment, the system determines, during a media streaming session of a user, that the user has selected a seed for the media streaming session using a media streaming application installed at a client device of the user. The system determines a playlist for the media streaming session that includes a plurality of media objects based on the seed. The system determines characteristics for each media object in the playlist, and compares the characteristics to the minimum criteria of candidate modes. The system identifies a subset of modes from the candidate modes for which the minimum criteria is met by the characteristics of the media objects. The system instructs the media streaming application to provide a selectable option of a mode of the subset for display.

### CROSS REFERENCE TO RELATED APPLICATIONS

This application claims the benefit of U.S. Provisional Application No. 62/820,185, filed Mar. 18, 2019, the disclosure of which is hereby incorporated by reference herein in its entirety.

### TECHNICAL FIELD

The disclosure generally relates to the field of digital content delivery over a network, and more particularly to improving quality of streaming content by providing improved network streaming of content relevant to listeners.

### BACKGROUND

Content streaming systems provide content to users over networks (e.g., the Internet). These systems provide a wide variety of content, such as music, video, and podcasts. Content streaming systems play back content to users during media streaming sessions. In related content streaming systems, a user initiates a media streaming session by selecting a seed. Using characteristics of the seed, current content steaming systems identify a set of content items (e.g., a playlist) that correspond to the seed, and play back the playlist to the user during the content streaming session. However, in current systems, the scope of content items that correspond to the seed is quite broad. As a result, current content streaming sessions often include content items the user is not in the mood for. For example, a user may initiate a streaming session by selecting a artist as the seed. The early and late work of the artist may have dramatically different styles, and the user may only enjoy listening to one of the styles. In current content streaming systems, the user is not able to select a subset content items the seed corresponds to. Instead, the user must manually skip and/or fast forward through content items the user dislikes during a content streaming session. This can be a tedious process and may negatively impact the listening experience of the user.

### SUMMARY

Systems and methods are disclosed herein for a content service providing mode-based recommendations to a user. When a user initiates a streaming session through a media streaming application, the content service identifies relevant content to play back to the user based on a seed of the media streaming session. A seed is any context from which content recommendations are made within the media streaming session. The seed may be a representation of the user's music preferences, listening habits, and the user's initiation of a media streaming session (e.g., how and when the session was initiated). Alternatively, or additionally, the seed may be a representation of an individual media object, such as a song, album, artist, podcast, and the like.

Because of the vast array of content that may be identified, the content service enables users to decide how content recommendations are guided during a media streaming session with modes. A mode is an option that a user can explicitly select that guides which recommendations are delivered to the user during a media streaming session. Each mode may be associated with a set of filters and scoring mechanisms that are used to generate a modified playlist for the user. For example, a “Newly Released” mode may include a filter that removes all content not released in the past 90 days. The newly released mode may also include a scoring mechanism that scores the filtered content based on a relevance between the filtered content and the seed for the media streaming session. Based on the scores of the filtered content, the content service recommends media objects to the user by playing back content from the modified playlist. The modified playlist may evolve based on changes in the user's listening habits, changes in music preferences, and changes in available music. Modes may similarly evolve.

A user interface of the content service determines which modes should be presented to a user. The user interface of the content service does this by identifying a set of modes that are relevant and applicable to the seed of the media streaming session. The user interface provides selectable options for the set of modes. When a user selects a selection option of a mode, the user interface updates the content being presented based on the modified playlist generating using the filters and scoring mechanisms of the selected mode.

In addition, the user interface may continually monitor and change the modes that are presented to the user as selectable options during a media streaming session. This ensures the content that is played during a media streaming session adapts to changes in the user's listening habits and preferences. To do this, the user interface of the content service monitors the user's interactions (e.g., liking, disliking, fast-forwarding) with content played back during a media streaming session. The content service updates the seed of the media streaming session based on one or more user interactions. The content service also updates playlist associated with the media streaming session based on the updated seed. Based on the updated seed and playlist, the content service determines if the previously presented modes are still relevant. In addition, the content service determines is additional or alternative modes are available. Based on these determinations, the content service identifies an updated set of modes to present to the user. In this way, the content service provides a listening experience that adapts with the user.

In an embodiment, the content service determines, during a media streaming session of a user, that the user has selected a seed for the media streaming session. A user may select a seed by explicitly selecting a media object. Alternatively, or additionally, a user may select a seed by initiating a media streaming session, interacting with a media object during the media streaming session, and the like. The content service determines a playlist of media objects for the media streaming session based on the seed. The playlist may include all recommendable content that corresponds to the seed, a portion of which may be played back to the user during the media streaming session. The content service determines characteristics for each media object in the playlist, and compares the characteristics to the minimum criteria of candidate modes. The content service identifies a subset of modes from the candidate modes for which the minimum criteria is met by the characteristics of the media objects. The content service instructs the media streaming application to provide for display a selectable option of a mode of the subset. In response to the user selecting a mode, the content service plays back media objects from the modified playlist associated with the selected mode.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram illustrating an environment for providing mode-based recommendations to listeners, according to one embodiment.

FIG. 2 is a high-level block diagram illustrating a detailed view of modules within the content server, according to one embodiment.

FIG. 3 is a high-level block diagram illustrating a detailed view of a mode recommendation module, according to one embodiment.

FIGS. 4A-4B are high-level block diagrams illustrating exemplary user interfaces of an application running on a client device, according to one embodiment.

FIG. 5 is a high-level block diagram illustrating an exemplary process of mode evolution, according to one embodiment.

FIGS. 6A-6B are high-level block diagrams illustrating additional exemplary user interfaces of an application running on a client device, according to one embodiment.

FIG. 7 is a high-level block diagram illustrating physical components of a computer used as part or all of a content server system or client device, according to one embodiment.

FIG. 8 is a flowchart illustrating an exemplary process for providing mode-based recommendations, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

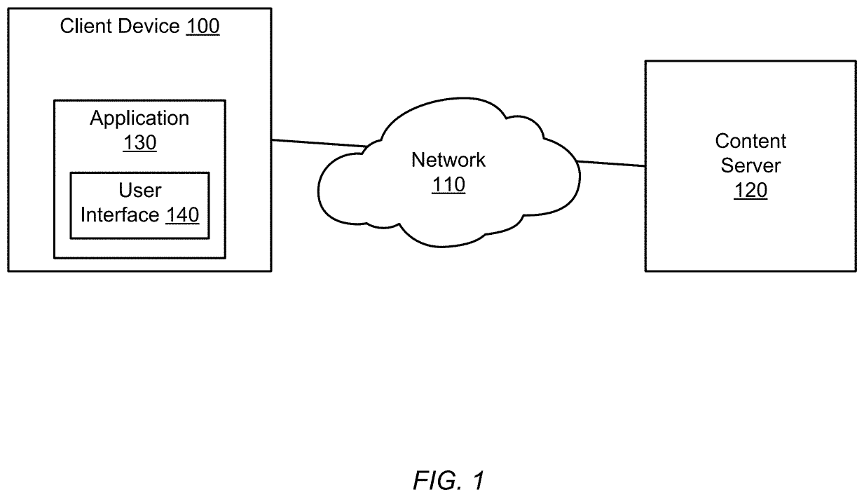

FIG. 1 is a high-level block diagram illustrating an embodiment of an environment for providing mode-based recommendations to listeners. The environment includes a client device 100 connected by a network 110 to a content server 120. Here only one client device 100 and content server 120 are illustrated but there may be multiple instances of each of these entities. For example, there may be thousands or millions of client devices 100 in communication with one or more content servers 120.

The network 110 provides a communication infrastructure between the client devices 100 and the content servers 120. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

Client device 100 is computing devices such as smartphones with an operating system such as ANDROID® or APPLE® IOS®, tablet computers, laptop computers, desktop computers, electronic stereos in automobiles or other vehicles, or any other type of network-enabled device on which digital content may be listened to or otherwise experienced. Typical client devices include the hardware and software needed to input and output sound (e.g., speakers and microphone) and images, connect to the network 110 (e.g., via Wifi and/or 4G or other wireless telecommunication standards), determine the current geographic location of the client devices 100 (e.g., a Global Positioning System (GPS) unit), and/or detect motion of the client devices 100 (e.g., via motion sensors such as accelerometers and gyroscopes).

The client device 100 includes an application 130 that allows interaction with the content server 120. For example, the application 130 could be a browser that allows a user of the client device 100 to obtain content by browsing a web site of the content server 120. As another example, the application 130 could be a dedicated application specifically designed (e.g., by the organization responsible for the content server 120) to enable interactions with the content server 120 and its content. In an embodiment, the client device 100 requests content be streamed from content server 120 by way of the web site of the content server 120 or the application 130.

The application 130 presents content (“media objects”) to users of the client devices 100. A media object may any playable form of media, such as a song, an album, a podcast, and the like. Therefore, the users are referred to as “listeners.” It is appreciated, however, that in other embodiments a content item alternatively and/or additionally includes other forms of digital content, such as videos. The application 130 requests or otherwise receives particular media objects from the content server 120. Media objects can be received by way of streaming or downloading from content server 120.

The application shown in FIG. 1 includes a user interface 140 for interacting with media objects streamed from the content server 120. Through the user interface 140, the listener may request content associated with an artist, genre, mood, or the like. Through elements of the user interface 140, the listener may provide direct feedback to media objects. For example, the listener may select a positive feedback icon, add the media object to a playlist, and the like. The listener may also provide indirect feedback to a media object via elements of the user interface 140. For example, the listener may fast forward through or skip a media object using a corresponding interface element. The feedback may be transmitted to content server 120 for storage in a user profile. These instances of direct and indirect feedback may be stored to a database and used to determine preferences of listeners for the purpose of making mode-based recommendations.

The content server 120 streams media objects to listeners, and provides mode-based recommendations based on a seed of a media streaming session of a listener. The term seed as used herein is any context from which content recommendations are made within the media streaming session (e.g., from which media objects are selected and played back to the listener). The seed may be a representation of the listener's music preferences, listening habits, and the listener's initiation of a media stream session (e.g., how and when the session was initiated). Alternatively, or additionally, the seed may be a representation of an individual media object, such as a song, album, artist, podcast, and the like.

The term mode as used herein may refer to an option that a user can explicitly select that guides which media objects are delivered to the user during a media streaming session. Modes are associated with a set of filters and scoring mechanisms that are used to generate a modified playlist from the playlist of the media streaming session. Filters remove media objects from the playlist of the media streaming session that do not meet a set of mode requirements. For example, a filter of a “Newly Released” mode may remove all media objects from the playlist that were not released within the last 90 days. Beyond removing media objects, a mode may additionally add media objects to a playlist that relate to both the mode and the seed.

Scoring mechanisms calculate a relevance between the filtered media objects and the seed of the media streaming session. Scoring mechanisms may score a media object based on a type and number of similar attributes between the media object and the seed. For example, a scoring mechanism of the “Newly Released” mode may score filtered media objects based on the number of similar attributes between media objects released within the last 90 days and the seed. Attributes may include, but are not limited to, band, genre, mood, tempo, and style. For example, if the seed is a media object in the “rock” genre, the scoring mechanism may assign higher scores to media objects that are also included in the “rock” genre.

In addition, scoring mechanisms may adjust the scores of media objects by assigning weights to media objects based on attributes of the media object. For example, a scoring mechanism of a “Newly Released” mode may weight media objects released within the last 7 days more heavily than media objects released within the last 45 days. As another example, a scoring mechanism for a “Discovery” mode may weight media objects released by lesser known artists more heavily than media objects released by established artists. Media objects are included in the modified playlist based on their respective scores. For example, a media object may be included in the modified playlist if the respective score of the media object is above a threshold score, if the respective score is within a threshold percentile, and the like. When a user selects a mode during a media streaming session, the content server plays back media objects from the modified playlist. Media objects from the modified playlist that are played back to the listener are referred herein as mode-based recommendations.

In addition to a set of filters and scoring mechanisms, modes may be associated with a set of minimum criteria. In some embodiments, a mode may be presented as a selectable option only when the minimum criteria of the mode are met. Minimum criteria of a mode may require the playlist of a media streaming session to include one or more characteristics, and may be based on the size of the playlist, the number of artists in the playlist, the number of genres or moods reflected in the playlist, and the like. For example, a mode may require a playlist of a media streaming session to include a threshold number of media objects, a threshold number of artists, and/or a threshold number of genres. Modes become available when the minimum criteria of a mode are met.

To provide mode-based recommendations, the content server 120 identifies a set of available modes to present to the user as selectable options on a user interface 140. The content server 120 identifies the set of available modes to present based on the seed of the media streaming session, the corresponding playlist, and the minimum criteria of modes. To do this, the content server 120 identifies a playlist of media objects associated with the seed of the media streaming session. Based on attributes of the playlist and the minimum criteria of the modes, the content server 120 identifies one or more available modes for which the minimum criteria have been met by the playlist. Available modes are provided to the listener as selectable options on the user interface 140 of the client device 100.

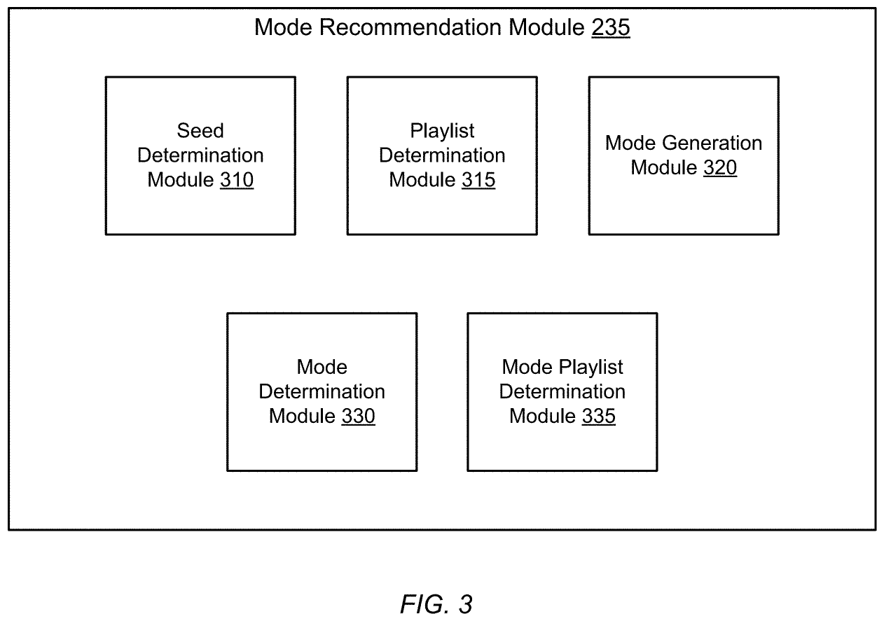

In response to the listener selecting a mode, the content server 120 modifies the playlist using the one or more filters and scoring mechanisms of the mode. The content server 120 plays back media objects from the modified playlist to the listener. The content server 120 may select a media object to play back based on the score of the media object, the seed of the media streaming session, user interactions, and the like, discussed in detail below with reference to FIG. 3.

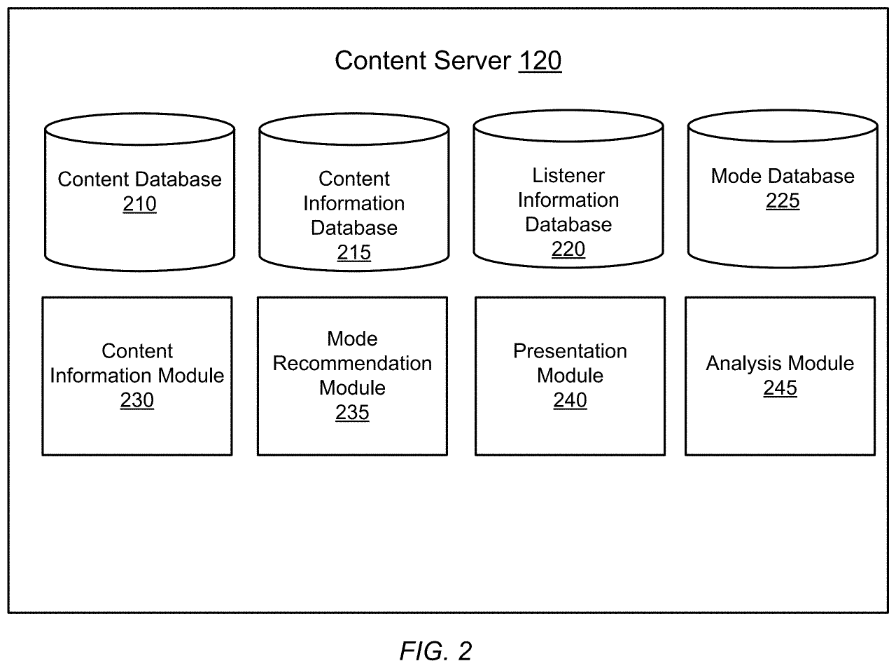

FIG. 2 is a high-level block diagram illustrating a detailed view of modules within the content server 120, according to one embodiment. The content server 120 shown in FIG. 2 includes a content database 210, a content information database 215, a listener information database 220, a mode database 225, a content information module 230, a mode recommendation module 235, a presentation module 240, and an analysis module 245. In other embodiments, the content server 120 may include additional, fewer, or different components for various applications.

A content database 210 stores media objects available for streaming over the network 110. Media objects may be stored in groups according to various configurations. Media objects may be grouped using corresponding information stored in the content information database 215. For example, media objects may be stored by genre, artist, mood, popularity, and the like. Listeners may elect to stream media objects in a particular group by selecting one or more groups using the user interface 140 of the client device 100. For example, a listener may select an instrumental jazz seed to initiate a media streaming session that plays back instrumental jazz. As new media objects are released, the content database may generate additional groupings and/or modify existing grouping. Additionally, the content database 210 may store modified playlists generated by the mode recommendation module 235.

A content information database 215 stores information about media objects stored in the content database 210. Information about songs includes song attributes, such as song type, tempo, and instrumental qualities. Song attributes may also include the corresponding artist, album, playlist, genre, etc., of the media object. The content information database 215 may also store information about artists, albums, podcasts, and the like. Artist information may include attributes describing the artist's body of work, number of albums released, upcoming works, number of followers, and relevant playlists. Album information include attributes describing an album holistically, number of times played, number of times queried, and relevant playlists, and the like.

Media object information may also include information describing user interactions with media objects. Listeners may passively interact with media objects by listening to media objects. Listeners may also actively interact with media objects using one or more interface elements provided on the user interface 140. For example, listeners may indicate a preference or aversion for a media object, follow a media object, fast-forward through a media object, replay a media object, and the like, using one or more interface elements. Therefore, information describing user interactions may include number of listens, number of followers, average listening time, and the like.

The content information module 230 generates the content information stored in the content information database 215. The content information module 230 may generate content information using machine learning techniques. Machine learning techniques may be used to classify media objects and determine media object attributes. Additionally, and/or alternatively, content information in the content information database 215 can be established using manual techniques or heuristics. At least some information may be supplied by publishers of the media objects. For example, the publishers may provide metadata, which may be used as attributes of the corresponding media objects.

A listener information database 220 stores information about listeners. Listener information may be stored in distinct user profiles, each corresponding to a different listener of the content server 120. Listener information may be provided explicitly by the listener (e.g., when a listener creates a profile with the content server 120). Listener information may also be obtained from third-party sources, such as social networks, and through inferences made by the content server 120 during one or more media streaming sessions. The listener information includes a combination of demographic information, taste information, social networking information, and interaction information. Demographic information may include any relevant demographic information, such as the listener's age, gender, and location. The taste information describes the listeners' preferences for media objects (e.g., podcasts, songs), expressed in terms of strength of association between a given listener and particular values of attributes of the media object (e.g., in the genome of the media object). Taste information may also describe the listeners' preferences for artists, genres, and the like. The interaction information describes the listeners' interactions with previously-presented media objects, such as whether the listener completed, rewound, fast-forwarded, skipped, and/or paused the media object. The social networking information describes social networking activities of listeners, such as interactions between two or more listeners, topics followed by listeners, and celebrities and/or entities listeners follow.

Some types of listener information may be absent for certain listeners. For example, some listeners may decline to provide social networking information. Further, listeners who are new to the content server 120 may lack taste and/or interaction information for one or more content items (e.g., taste and/or interaction information may be present for songs, but not for podcasts).

The mode database 225 stores modes and their corresponding criteria. For each mode, the mode database 225 stores the corresponding set of filters and scoring mechanisms. The mode database 225 also stores the minimum criteria that must be met in order for the corresponding mode to be provided as a selectable option to a listener. In addition, the mode database 225 may store information indicating how and when a mode was historically applied to a playlist of a media streaming session. For example, the mode database 225 may store information indicating which seed was used to initiate the media streaming session, demographic information of listeners that have selected the mode, and information describing user interactions between listeners and media objects from the modified playlist of the corresponding mode.

The mode recommendation module 235 identifies and ranks available modes for a media streaming session of a listener. The mode recommendation module 235 identifies available modes based on the minimum criteria of the modes stored in the mode database 225. The mode recommendation module 235 ranks the available modes based on listener preferences, listener demographics, and the like, discussed in detail below with reference to FIG. 3. Based on the rankings of the available modes, the mode recommendation module 235 instructs the user interface 140 to provide for display selectable options for a set of the available modes.

Responsive to a listener selecting an available mode, the mode recommendation module 235 generates a modified playlist for the media streaming session based on the filters and/or scoring mechanisms of the selected mode. The mode recommendation module 235 determines which media objects from the modified playlist to play back during the media streaming session. The mode recommendation module 235 may determine which media object to play back via sampling, discussed in detail below with reference to FIG. 3.

The mode recommendation module 235 also monitors listener interactions with media objects in the modified playlist. Based on the interactions, the mode recommendation module 235 may update mode rankings, modify mode criteria, update modified playlists, update the seed of the media streaming session, and/or provide selectable options for a different set of available modes.

A presentation module 240 presents selectable options for available modes to listeners. In one embodiment, the presentation module 240 obtains a ranked set of available modes from the mode recommendation module 235. The presentation module 240 presents the ranked set of available modes for display on the user interface 140 of the client device 100. For example, the presentation module 240 may present the ranked set of modes on the user interface in the form of a ranked list, where the more highly ranked modes are presented at the top of the ranked list. In addition, the presentation module 240 may select a subset of the set of ranked modes based on the rankings of the set, a maximum number of selectable options to be displayed on the user interface 140, and the like. The presentation module 240 also plays back media objects to listeners. When a user selects an available mode, the presentation module 240 obtains media objects to play back from the mode recommendation module 235.

An analysis module 245 provides reports resulting from analyses of the content information and/or listener information. The analysis module 245 collects information describing usage of the content server 120, including what modes were provided to listeners, which media objects were played back in response to a mode selection, and how the listeners reacted to the recommendations. The analysis module 245 uses the content information, the listener information, and the mode information to generate metrics describing what content within the media objects is being consumed by different listeners. These metrics provide detailed insights into what types of listeners are listening to what types of media objects. The metrics may be fed back to one or more modules of the mode recommendation module 235, for example, to improve recommendations, improve other aspects of the content server 120, and the like. In particular, the selection rates of modes may be used to determine which modes are provided as selectable options to listeners, demographic information may be used to determine which media objects should be sampled to different users during media streaming sessions, and the like.

FIG. 3 is a high-level block diagram illustrating a detailed view of a mode recommendation module 235, according to one embodiment. The mode recommendation module 235 shown in FIG. 3 includes a seed determination module 310, a playlist determination module 315, a mode generation module 320, a mode determination module 330, and a mode playlist determination module 340. In other embodiments, the content server 120 may include additional, fewer, or different components for various applications.

A seed determination module 310 determines a seed for a listener and/or media streaming session of a listener based on user input. User input may include a search query, historical input, such as past interactions with the content service, and/or a combination thereof. The seed determination module 310 may update a seed at a predetermined frequency, in response to the user's interactions with the content server 120, a media object, a mode, a playlist, and the like. A user may be associated with multiple seeds, where each seed is associated with different characteristics describing the user and the user's listening behavior. Different seeds may be associated with different listening environments, moods, and the like. For example, a seed may be a workout seed that includes characteristics of the user's music preferences and listening habits while exercising (e.g., preferred genre, tempo, song length, and the like). In these embodiments, a user may explicitly select a seed. Alternatively, the seed determination module 310 may infer which seed to use during a media streaming session based on a query of the user.

The playlist determination module 315 determines a playlist for a media streaming session using the seed determined by the seed determination module 310. The playlist determination module 315 passes a current seed through a recommendation framework, which includes a set of rules guiding how a seed is transformed into a playlist for a media streaming session. Using the recommendation framework, the playlist determination module 315 transforms the current seed into an output playlist that includes media objects that correspond to the seed. For example, using the recommendation framework, the playlist determination module 315 identifies a set of media objects that correspond to the seed based on attributes of media objects stored in the content database 210 and attributes of the seed. From the set of media objects, the playlist determination module 315 selects a subset of media objects (e.g., a playlist). The playlist determination module 315 may select the subset of media objects based on attributes of individual media objects, attributes of the subset as a whole, listener behavior and preferences, and the like. The presentation module 240 may then play back media objects to the listener during a corresponding media streaming session. 10048j In addition, the playlist determine module 315 may update and/or determine new playlists as additional content is added to the content database 210 (e.g., as new music and/or podcasts are released). The playlist determination module 315 may do this by iteratively passing a current seed through the recommendation framework as new content becomes available.

Further, the playlist determination module 315 may update and/or determine new playlists as the seed determination module 310 updates seeds. For example, in response to a listener indicating a preference for a song during a media streaming session, the seed determination module 310 updates the seed to account for the indicated preference. The playlist determination module 315 may then update the playlist for the media streaming session by identifying media objects that correspond to the updated seed. In such embodiments, the playlist determination module 315 passes updated seeds through the recommendation framework to determine corresponding updated playlists. Additionally, aggregate usage and feedback in the content service may alter the representation of a media object that indicates that it is appropriate for a given seed where previous data for this media object indicated that it was not appropriate. Based on the indication, the playlist associated with the seed may include additional media objects.

The mode generation module 320 generates a modified playlist for a media streaming session of a listener using one or more modes. The mode generation module 320 generates modified playlists based on the playlist associated with a current seed and the filters and scoring mechanisms of one or more modes. To generate a modified playlist, the mode generation module 320 applies one or more filters of a mode to the playlist associated with the seed. The mode generation module 320 then applies one or more scoring mechanisms of the mode to the filtered playlist to return a subset of the playlist, referred to as a modified playlist. For example, to generate a modified playlist using a “Crowd Faves” mode, the mode generation module 320 may filter out media objects that have not been selected as seeds by listeners, or may filter out media objects that are not trending and/or have not trended within a threshold period of time from the present. The mode generation module 320 may score media objects based on their corresponding attributes and the attributes of the seed. The mode generation module 320 may also score media objects based on a corresponding listening rate, number of likes, number of dislikes, number of followers, etc. The mode generation module 320 includes a subset of the scored media objects in the modified playlist based on the respective scores of the media objects.

Alternatively, or additionally, the mode generation module 320 may generate a modified playlist directly from the media objects stored in the content database 210. In these embodiments, the mode generation module 320 may filter some or all of the media objects stored in the content database 210 with the one or more filters of a corresponding mode. The filtered media objects are scored using the one or more scoring mechanisms of the corresponding mode. The score of a media object may indicate a relevance between the media object and the seed of the media streaming session, a likelihood the media object will be played back during the media streaming session, and the like. Based in part on the scores of the media objects, the mode generation module 320 selects a subset of the filtered and scored media objects to include in the modified playlist.

The mode generation module 320 may generate a modified playlist in response to a listener selecting a mode via an interface element of the user interface 140. The mode generation module 320 may also generate modified playlists in response to a listener initiating a media streaming session, interacting with a media object, and the like.

Some modes may be associated with minimum criteria that must be met by the playlist of a media streaming session before a mode is provided as a selectable option to a listener. Minimum criteria may include a threshold number of artists, a threshold number of media object, a threshold number of genres to be reflected in the playlist, and the like. For example, there may be requirements around the number of unique artists attributes to individual media objects in the mode to deliver a sustained media streaming experience.

If a mode is associated with minimum criteria, the mode generation module 320 determines whether the characteristics of the media objects in the playlist meet the minimum criteria. For example, the mode generation module 320 may determine whether a threshold number of media objects exist within the playlist, whether a threshold number of artists are reflected in the playlist, or whether any other type of threshold is reflected within the playlist based on the minimum criteria of the mode. In such embodiments, the mode recommendation module 235 may refrain from offering selectable options for one or more modes should thresholds corresponding to those particular modes not be met. Thus, in some embodiments, artist-level diversity needs to be reflected in the original playlist of a media streaming session in order to deliver particular modes.

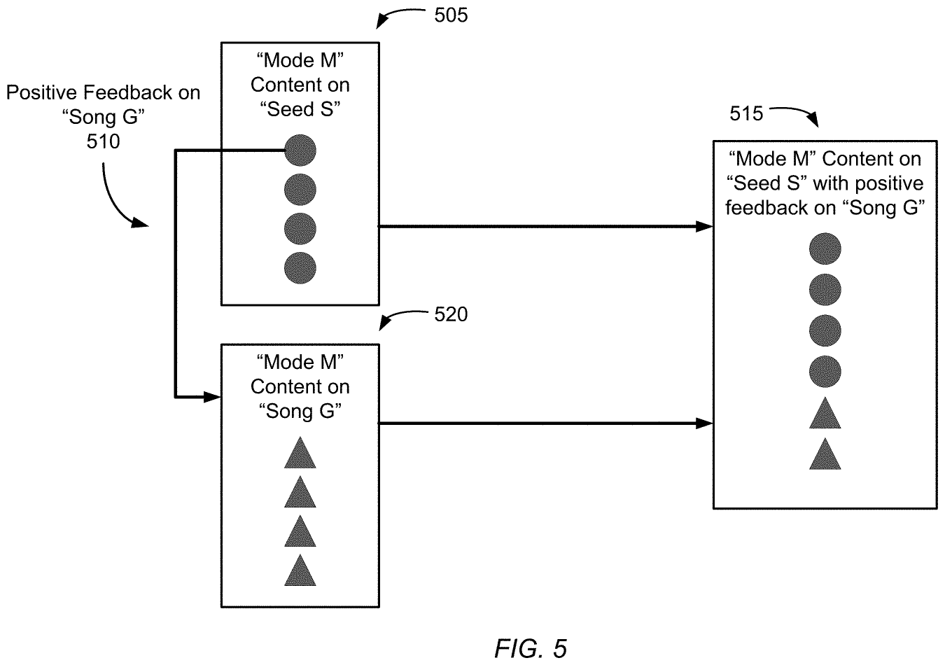

In some embodiments, the mode generation module 320 updates a modified playlist as the playlist determination module 315 updates the corresponding playlist and/or as the seed determination module 310 updates the corresponding seed. In addition, the mode generation module 320 may identify additional modes that are available based on the updated playlists. For example, the mode generation module 320 may determine that the characteristics of the updated playlist now meet the minimum criteria of a mode that were not previously met by the characteristics of the original playlist. An example of this is described in detail with reference to FIG. 5.

The mode determination module 330 determines which available modes to recommend to the listener during a media streaming session. The mode determination module 330 may do this using information detailing previous interactions between the listener and the content server 120 (e.g., prior selections of modes, listening habits, music preferences, etc.). For example, the mode determination module 330 may identify which available modes are consistently selected by the listener to identify a personalized set of available modes. The personalized set of modes may be ranked based on a likelihood the user will select the mode.

The mode determination module 320 may also determine which available modes to recommend based on the configuration of the user interface 140. For example, the mode determination module 320 may determine the number of modes to recommend based on a maximum number of modes to be displayed together on the user interface 140. The mode determination module 320 may determine the maximum number of modes to be displayed together based on the size of a display of the client device 100, listener preferences, user interface usability guidelines (e.g., interface element and font size guidelines), and the like. The mode determination module 330 may also determine which modes to recommend based on rankings of the available modes. To do this, the mode determination module 330 ranks modes based on the scores of the media objects in each modified playlist, the popularity of the mode among listeners of the content service 120, and the like.

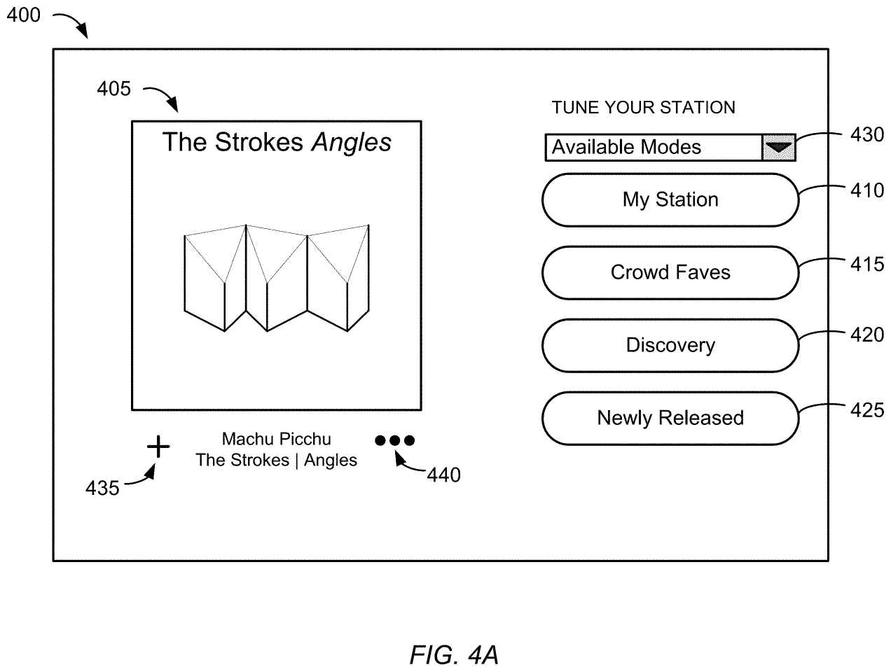

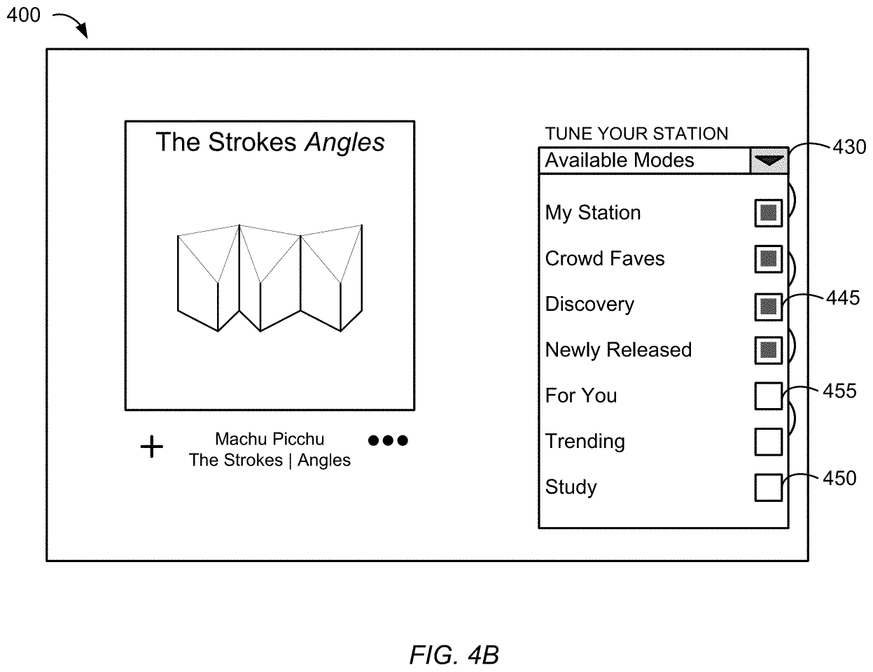

In addition, the mode determination module 330 may determine which available modes are compatible with each other. Modes may be compatible when the modified playlist generated using their respective filters and scoring mechanisms meet a set of requirements. Requirements may include a threshold number of media objects, a threshold length of time, a threshold number of artists, and the like. Requirements help ensure that the modified playlist can sustain a media streaming session. Examples of compatible modes are discussed in detail below with reference to FIG. 4A.

The mode playlist determination module 335 determines which media objects within a modified playlist are provided to the listener during a media streaming session. In some embodiments, the mode playlist determination module 335 identifies particular media objects to play back to the listener through sampling. Sampling is a process in which a media object is selected based on the scores of the media objects in the modified playlist determined by the one or more scoring mechanisms of the mode. To sample a media object, the mode playlist determination module 335 may compare the score associated with the media object and the scores associated with some or all of the media objects in the modified playlist. Based on this comparison, the mode playlist determination module 335 may sample the media object and provide it to the listener.

The method of providing a sampled media object to a listener may vary. For example, the mode playlist determination module 335 may provide a sampled media object by playing it back to the listener. Alternatively, or additionally, the mode playlist determination module 335 may provide sampled media objects by incorporating a set of sampled media objects into the modified playlist of the media streaming session.

The mode playlist determination module 335 may sample a media object through weighted random sampling. When the mode playlist determination module 335 uses weighted random sampling to recommend a media object, it uses the scores of the media objects as weights. The weights determine the likelihood that the presentation module 240 will select and play back the media object. In weighted random sampling, a media object that has a high score is more likely to be selected than a media object with a low score. However, all media objects within the modified playlist are eligible to be selected.

Alternatively, or additionally, the mode playlist determination module 335 may sample a media object through deterministic sampling. When the mode playlist determination module 335 uses deterministic random sampling to recommend a media object, media objects are selected based on their respective scores. This method helps ensure the most relevant media objects are recommended to the user, which may be useful when the media objects are being presented as a list of content to the listener. The mode playlist determination module 335 provides the recommendations to the presentation module 240 such that the recommendations are provided to the listener.

FIGS. 4A-4B are high-level block diagrams illustrating exemplary user interfaces of an application running on a client device 100, according to one embodiment. The user interface 400 shown in FIG. 4A may be provided to a listener during a media streaming session in which the listener is streaming a playlist. A portion of the user interface 400 includes a description area 405 providing information on a currently-playing media object, such as the name of the media object, the artist, album, etc. Based on the user's seed for the media streaming session, one or more selectable options for modes identified by the mode determination module 330 are displayed to the user as selectable options. In the example shown, selectable options for the “My Station” mode 410, “Crowd Faves” mode 415, “Discovery” mode 420, and “Newly Released” mode 425 are displayed. When a listener selects the selectable option for the “My Station” mode 410, media objects that have been liked by the listener may be played. When a listener selects the selectable option for the “Crowd Faves” mode 415, media objects that are popular among all listeners of the content server 120 may be played. When a listener selects the selectable option for the “Discovery” mode 420, media objects that have not yet been played back to the listener may be played. When a listener selects the selectable option for the “Newly Released” mode 425, media objects released within the last 14 days may be played.

In some embodiments, the user interface 400 includes a scrolling interface element (not shown) that allows the user to scroll through the set of selectable options displayed on the user interface 400. As an example, the maximum number of selectable options to be displayed on the user interface may be four selectable options. However, the mode determination module 330 may identify five or more modes to recommend. By including the scrolling interface element, selectable options for the five or more modes may be provided to the listener without exceeding the maximum number of selectable options to be displayed at a given time.

The order in which the selectable options for the modes are displayed may be based on the rankings of the modes, as discussed above with reference to FIG. 3. The user interface 400 shown also includes an available modes interface element 430. The available modes interface element 430 allows the user to determine which selectable options for modes are displayed on the user interface 400 during a media streaming session, discussed in detail below with reference to FIG. 4B.

The user interface 400 also includes additional interface elements, such as interface element 435 and interface element 440, that allow the user to interact with the media object being played. For example, interface element 435 may allow the user to indicate a preference for the media object, save, and/or follow the media object to a playlist. Interface element 440 may allow the user to view additional information about the media object, indicate an aversion for the media object, the artist associated with the media object, and the like. In other embodiments, the user interface 400 may include additional, fewer, or different interface elements. For example, the user interface 400 may include playback controls to pause, skip, fast forward, rewind, etc., a currently playing media object.

In some embodiments, more than one selectable option of a mode may be selected. In these embodiments, when a user selects a first selectable option of a mode, the user interface 400 may be updated to display one or more additional modes that are compatible with the first mode, as determined by the mode determination module 330. The user may then select a second mode from the one or more additional modes to be applied to the playlist of the media streaming session. An example of compatible modes includes a “Newly Released” mode 425 and a “Crowd Faves” mode 415. The modified playlist generated from the combination of these modes may include media objects that have been released within the last week and have a listening frequency greater than a threshold frequency. An additional example of compatible modes may include a “Discovery” mode 420 and a “Study” mode. The modified playlist generated from the combination of these modes may include media objects that have not been played by the user and that include attributes associated with a studying genre.

FIG. 4B illustrates an embodiment of an expanded view of the available modes interface element 430. When a listener selects the available modes interface element 430, a list of available modes is provided for display. The available modes may be ordered based on ranking, alphabetical order, likelihood of listener selection, playlist size, and the like. In some embodiments, the list of available modes only includes those modes whose minimum criteria have been met by the characteristics of the playlist of the media streaming session. In other embodiments, all modes are provided in the list. In such embodiments, the list may indicate which modes are currently available for the media streaming session. In some embodiments, the number of modes displayed as selectable options may be limited such that the listener may only select a threshold number of modes to be displayed.

The list may indicate which available modes are currently displayed as selectable options on the user interface 400. For example, checkbox 445 indicates that the “Discovery” mode is provided as a selectable option on the user interface 400, and checkbox 450 indicates that the study mode is not provided as a selectable option. In some embodiments, the user may select a mode to be applied to a playlist of a media streaming session directly from the list using one or more interface elements.

In addition to the available modes, the list may include a checkbox for a “For You” setting 455. When selected, the “For You” 455 setting provides for display the personalized set of selectable options for modes as determined by the mode determination module 330. Therefore, when a listener selects the “For You” setting 455, selectable modes are displayed to the listener in a personalized way.

FIG. 5 is a high-level block diagram illustrating an exemplary process of mode evolution, according to one embodiment. As previously discussed, media streaming sessions of a listener are associated with a seed, e.g., “seed S.” The seed determines which media objects are recommended to the user. When a user selects a mode, e.g., “mode M,” the mode generation module 320 generates a modified playlist 505 by applying the one or more filters and scoring mechanisms of the selected mode to the playlist corresponding to the seed. In some embodiments, when the user interacts with a media object of the modified playlist, e.g., “song G,” the seed of the media streaming session is modified based on the interaction. As shown, the listener's interaction with song G that indicates positive feedback on song G 510. The positive feedback on song G may be used to update seed S. The mode generation module 320 applies mode M to updated seed S to generate a further modified playlist 515.

Alternatively, or additionally, the seed for the media streaming session is not explicitly modified. Instead, the media object the listener interacted with is identified as an additional seed for the media streaming session. The mode generation module 320 applies mode M to the playlist associated with the additional seed to generate a modified playlist 520 for the additional seed. The mode generation module 320 may then generate a new playlist 515 that includes a combination of media objects in the modified playlist for seed S 505 and the modified playlist for song G 520.

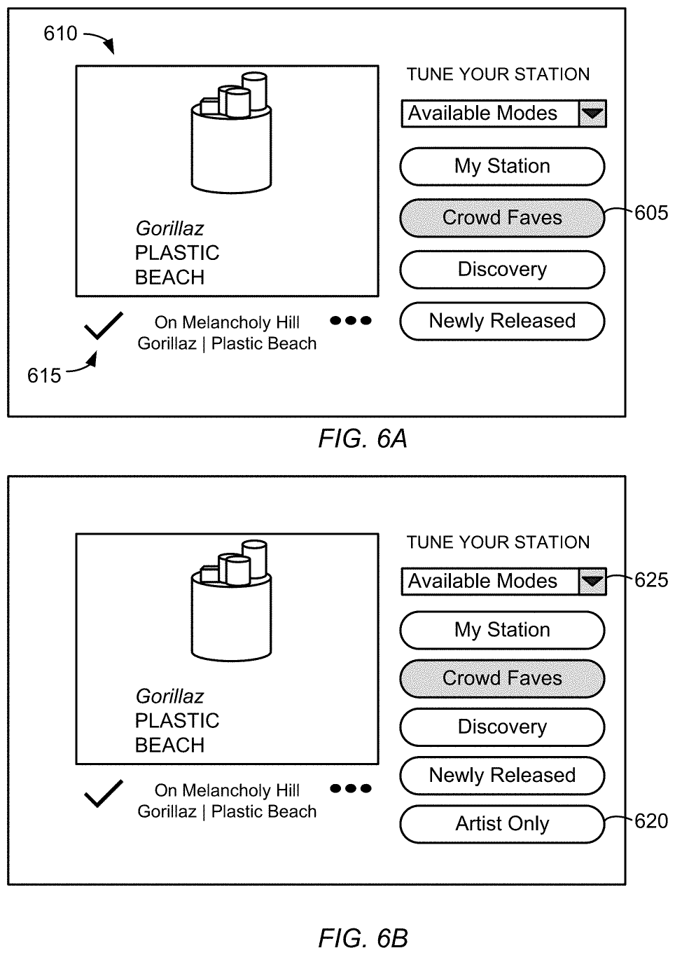

FIG. 6A-6B are high-level block diagrams illustrating exemplary user interfaces of an application 130 running on a client device 100, according to one embodiment. The example user interface 140 indicates that the listener selected a crowd faves mode 605. Based on the selection, the presentation module 240 is playing back a media object 610 included in the modified playlist and recommended by the mode playlist determination module 335. The example user interface includes an interface element 615 that indicates that listener provided positive feedback for the media object 610 currently being played. Based on the feedback provided by the listener, the seed determination module 310 may updated seed for the media streaming session, and the playlist determination module 315 may update the corresponding playlist. The mode generation module 320 generates a further modified playlist for the media streaming session using the updated seed and updated playlist.

As shown in FIG. 6B, the mode generation module 320 may also identify additional modes that are available based on the further modified playlist. For example, the example user interface 140 has been modified to include a selectable option for the artist only mode 620. Additional modes that are available may also be viewed and/or selected using the available modes interface element 625.

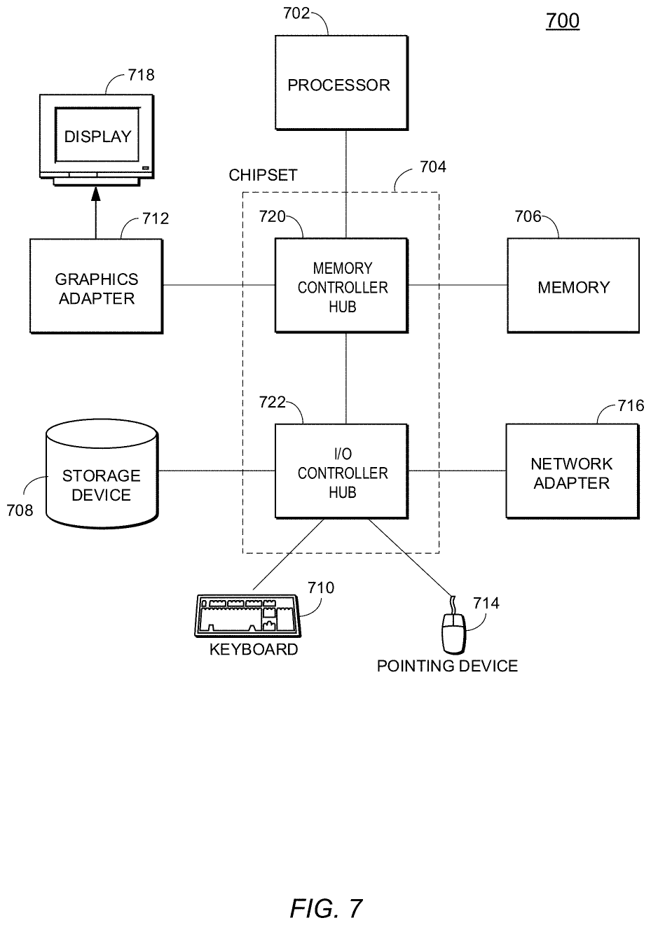

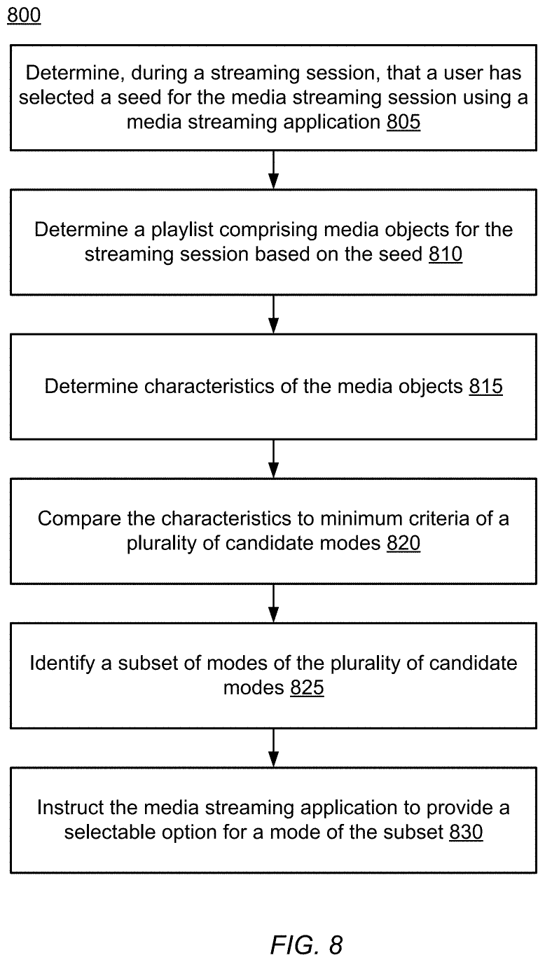

FIG. 7 is a high-level block diagram illustrating physical components of a computer used as part or all of a content server system or client device, according to one embodiment. The computer 700 includes at least one processor 702 coupled to a chipset 704. The chipset 704 includes a memory controller hub 420 and an input/output (I/O) controller hub 722. A memory 706 and a graphics adapter 712 are coupled to the memory controller hub 720, and a display 718 is coupled to the graphics adapter 712. A storage device 708, an input device 714, and network adapter 716 are coupled to the I/O controller hub 722. Other embodiments of the computer 700 have different architectures.

The storage device 708 is a non-transitory computer-readable storage medium such as a hard drive, compact disk read-only memory (CD-ROM), DVD, or a solid-state memory device. The memory 706 holds instructions and data used by the processor 702. The input interface 714 is a touch-screen interface, a mouse, track ball, or other type of pointing device, a keyboard, or some combination thereof, and is used to input data into the computer 700. In some embodiments, the computer 700 may be configured to receive input (e.g., commands) from the input interface 714 via gestures from the user. The graphics adapter 712 displays images and other information on the display 718. The network adapter 716 couples the computer 700 to one or more computer networks.

The computer 700 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computers 700 used by the entities of FIG. 1 can vary depending upon the embodiment and the processing power required by the entity. For example, the content server 120 can run in a single computer 700 or multiple computers 700 communicating with each other through a network such as in a server farm. The computers 700 can lack some of the components described above, such as graphics adapters 712, and displays 718.

FIG. 8 is a flowchart illustrating an exemplary process for providing mode-based recommendations, according to one embodiment. The seed determination module 310 determines 805, during a media streaming session at a client device 100 of a user, that the user has selected, using a media streaming application 130 installed at the client device 100, a seed for the media streaming session. For example, the user may select a seed by interacting with one or more interface elements of the user interface 140 of the client device 100 using a keyboard 710 and/or pointed device 715. The playlist determination module 315 determines 810 a playlist for the media streaming session based on the seed. The playlist includes a plurality of media objects that correspond to the seed. The content information module 230 determines 815 characteristics for each of the media objects in the playlist. The mode generation module 320 compares 820 the characteristics to respective minimum criteria of each respective one of a plurality of candidate modes. The mode generation module 320 identifies 825 a subset of modes of the plurality of candidate modes for which the respective minimum criteria is met by the characteristics of the media objects of the playlist (e.g., available modes). The mode determination module 330 instructs 830 the media streaming application 130 to provide a selectable option for a mode of the subset for display on the user interface 140.

The user may then select the mode using the keyboard 710 or pointing device 714. In response to the user selecting the mode, the mode generation module 320 determines a modified playlist for the media streaming session based on a filter and/or scoring mechanism of the selected mode. The mode playlist determination module 335 recommends one or more media objects from the modified playlist to the user.

### OTHER CONSIDERATIONS

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for selecting content based on correlations between preferred media features and specific configurations of environmental information. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

What is claimed is:

1. A method comprising:
determining, during a media streaming session at a client device of a user, that the user has selected, using a media streaming application installed at the client device, a seed for the media streaming session;
determining, based on the seed, a playlist for the media streaming session, the playlist comprising a plurality of media objects;
determining characteristics for each of the plurality of media objects;
comparing the characteristics to respective minimum criteria of each respective one of a plurality of candidate modes;
identifying a subset of modes of the plurality of candidate modes for which the respective minimum criteria is met by the characteristics; and
instructing the media streaming application to provide for display a selectable option for a mode of the subset.

2. The method of claim 1, further comprising:
ranking the subset of modes of the plurality of candidate modes;
instructing the media streaming application to provide for display a selectable option for each of a first plurality of modes in the subset based on the ranking;
determining, during the media streaming session at the client device of the user, that the user has interacted with a media object of a modified playlist generated based on a selected mode;
responsive to determining that the user has interacted with the media object of the modified playlist, reranking the subset of modes; and
instructing the media streaming application to provide for display a selectable option for each of a second plurality of modes in the subset based on the reranking.

3. The method of claim 1, further comprising:
ranking the subset of modes of the plurality of candidate modes;
determining, based on a configuration of a user interface of the media streaming application, a maximum number of selectable options for modes to be displayed together on the user interface; and
instructing the media streaming application to provide for display a selectable option for each of a plurality of modes based on the ranking and the maximum number of selectable options.

4. The method of claim 1, further comprising:
determining, during the media streaming session at the client device, that the user has selected a mode of the subset;
modifying the playlist for the media streaming session based on the selected mode; and
instructing the media streaming application to play back the modified playlist during the media streaming session.

5. The method of claim 4, wherein modifying the playlist for the streaming session based on the selected mode comprises:
filtering the plurality of media objects of the playlist based on a filter of the selected mode;
scoring the filtered plurality of media objects based on a scorer of the selected mode; and
selecting a set of media objects from the filtered plurality of media objects based on the respective scores of the respective media objects.

6. The method of claim 4, wherein each media object of the modified playlist includes a score, and wherein instructing the media streaming application to play back the modified playlist further comprises:
instructing the media streaming application to play back a media object of the modified playlist based on the respective score of the respective media object.

7. The method of claim 6, wherein the respective score of a respective media object represents a likelihood the media streaming application will select the respective media object during the media streaming session.

8. The method of claim 1, further comprising:
determining, during the media streaming session at the client device, that the user has selected a mode of the subset;
identifying a plurality of additional media content objects based on the selected mode; and
updating the playlist for the media streaming session to include the plurality of additional media content objects.

9. The method of claim 1, further comprising:
determining, during the media streaming session at the client device, that the user has selected a first mode of the subset;
determining a second subset of modes that are compatible with the first mode;
instructing the media streaming application to provide for display a selectable option for each mode of the second subset;
determining that the user selected a second mode of the second subset; and
modifying the playlist for the streaming session to include a set of media content objects based on the first mode and the second mode.

10. The method of claim 1, further comprising:
determining, during the media streaming session at the client device, that the user has selected a mode of the subset;
modifying the playlist based on the selected mode; and
instructing the media streaming application to play back the modified playlist;
determining, during the media streaming session, that the user has interacted with a media object of the modified playlist;
responsive to determining that the user interacted with the media object of the modified playlist, further modifying the playlist; and
instructing the media streaming application to play back the further modified playlist during the media streaming session

11. The method of claim 1, wherein the seed is a first seed, the method further comprising:
identifying, during the media streaming session at the client device, a second seed for the media streaming session;
determining, based on the first seed and the second seed, a modified playlist for the media streaming session, the modified playlist including a plurality of media objects;
determining characteristics for each of the plurality of media objects of the modified playlist;
comparing the characteristics of the plurality of media objects of the modified playlist to respective minimum criteria of each respective one of the plurality of candidate modes;
identifying an additional candidate mode for which the respective minimum criteria is met by the characteristics of the plurality of media objects of the modified playlist; and
instructing the media streaming application to provide for display a selectable option for the additional candidate mode.

12. A non-transitory computer readable medium configured to store instructions, the instructions when executed by a processor cause the processor to perform operations, the instructions comprising instructions to:
determine, during a media streaming session at a client device of a user, that the user has selected, using a media streaming application installed at the client device, a seed for the media streaming session;
determine, based on the seed, a playlist for the media streaming session, the playlist comprising a plurality of media objects;
determine characteristics for each of the plurality of media objects;
compare the characteristics to respective minimum criteria of each respective one of a plurality of candidate modes;
identify a subset of modes of the plurality of candidate modes for which the respective minimum criteria is met by the characteristics; and
instruct the media streaming application to provide for display a selectable option for a mode of the subset.

13. The non-transitory computer readable medium of claim 12, the instructions further comprising instructions to:
rank the subset of modes of the plurality of candidate modes;
instruct the media streaming application to provide for display a selectable option for each of a first plurality of modes in the subset based on the ranking;
determine, during the media streaming session at the client device of the user, that the user has interacted with a media object of a modified playlist generated based on a selected mode;
responsive to determining that the user interacted with the media object of the modified playlist, reranking the subset of modes; and
instruct the media streaming application to provide for display a selectable option for each of a second plurality of modes in the subset based on the reranking.

14. The non-transitory computer readable medium of claim 12, the instructions further comprising instructions to:
rank the subset of modes of the plurality of candidate modes;
determine, based on a configuration of a user interface of the media streaming application, a maximum number of selectable options for modes to be displayed together on the user interface; and
instruct the media streaming application to provide for display a selectable option for each of a plurality of modes based on the ranking and the maximum number of selectable options.

15. The non-transitory computer readable medium of claim 12, the instructions further comprising instructions to:
determine, during the media streaming session at the client device, that the user has selected a mode of the subset;
modify the playlist for the media streaming session based on the selected mode; and
instruct the media streaming application to play back the modified playlist during the media streaming session.

16. A system, for providing a recommendation personalized to a user, comprising:
one or more processors; and
memory storing one or more programs to be executed by the one or more processors, the one or more programs causing the one or more processors to perform operations comprising:
determining, during a media streaming session at a client device of a user, that the user has selected, using a media streaming application installed at the client device, a seed for the media streaming session;
determining, based on the seed, a playlist for the media streaming session, the playlist comprising a plurality of media objects;
determining characteristics for each of the plurality of media objects;
comparing the characteristics to respective minimum criteria of each respective one of a plurality of candidate modes;
identifying a subset of modes of the plurality of candidate modes for which the respective minimum criteria is met by the characteristics; and
instructing the media streaming application to provide for display a selectable option for a mode of the subset.

17. The system of claim 16, wherein the one or more programs cause the one or more processors to perform operations further comprising:
determining, during the media streaming session at the client device, that the user has selected a mode of the subset;
identifying a plurality of additional media content objects based on the seed for the media streaming sessions and the selected mode; and
updating the playlist for the media streaming session to include the plurality of additional media content objects.

18. The system of claim 16, wherein the one or more programs cause the one or more processors to perform operations further comprising:
determining, during the media streaming session at the client device, that the user has selected a first mode of the subset;
determining a second subset of modes that are compatible with the first mode;
instructing the media streaming application to provide for display a selectable option for each mode of the second subset;
determining that the user selected a second mode of the second subset; and
modifying the playlist for the streaming session to include a set of media content objects based on the first mode and the second mode.

19. The system of claim 16, wherein the one or more programs cause the one or more processor to perform operations further comprising:
determining, during the media streaming session at the client device, that the user has selected a mode of the subset;
modifying the playlist based on the selected mode; and
instructing the media streaming application to play back the modified playlist;
determining, during the media streaming session, that the user has interacted with a media object of the modified playlist;
responsive to determining that the user interacted with the media object of the modified playlist, further modifying the playlist; and
instructing the media streaming application to play back the further modified playlist during the media streaming session.

20. The system of claim 16, wherein the seed is a first seed, and wherein the one or more programs cause the one or more processors to perform operations further comprising:
identifying, during the media streaming session at the client device, a second seed for the media streaming session;
determining, based on the first seed and the second seed, a modified playlist for the media streaming session, the modified playlist including a plurality of media objects;
determining characteristics for each of the plurality of media objects of the modified playlist;
comparing the characteristics of the plurality of media objects of the modified playlist to respective minimum criteria of each respective one of the plurality of candidate modes;
identifying an additional candidate mode for which the respective minimum criteria is met by the characteristics of the plurality of media objects of the modified playlist; and
instructing the media streaming application to provide for display a selectable option for the additional candidate mode.
